(19) United States
(12) Patent Application Publication
(10) Pub. No.: US 2018/0338349 A1
(43) Pub. Date: Nov. 22, 2018

(54) NOVEL CRYSTAL SALT AROMA STOVE

(71) Applicant: Xiaoyuan Ma, Shenzhen (CN)

(72) Inventor: Xiaoyuan Ma, Shenzhen (CN)

(21) Appl. No.: 15/602,098

(22) Filed: May 22, 2017

(30) Foreign Application Priority Data
May 16, 2017 (CN) 201720538081.X

(51) Int. Cl. H05B 1/02

(52) U.S. Cl. CPC H05B 1/0244; H05B 2203/021

(57) ABSTRACT

The utility model discloses a novel crystal salt aroma stove which comprises an aroma stove body, a base and a built-in circuit control system. There is the aroma stove body, a cover, an aromatherapy oil placing groove, a protective screen, the base, a threading hole, a glass cover, a crystal salt placing groove, a heating bulb and a glass cover installing groove. The built-in circuit control system is arranged in the base of the aroma stove body. A power supply module and a light control module are arranged on the built-in circuit control system. The novel crystal salt aroma stove is reasonable in design, attractive in appearance, simple and elegant, has an effect of air purification through crystal salt besides a function of aromatherapy and air beautification which an existing aroma stove can only perform, and enables users to breathe pure air, experience aesthetic sentiments, relax tense nerves and return to simple nature.

### CROSS-REFERENCE TO RELATED APPLICATIONS

This application claims priority to Chinese Patent Application No. 201720538081.X with a filing date of May 16, 2017. The content of the aforementioned applications, including any intervening amendments thereto, are incorporated herein by reference.

### TECHNICAL FIELD

The utility model relates to the technical field of daily supplies, and in particular to a novel crystal salt aroma stove.

### BACKGROUND OF THE PRESENT INVENTION

With continuous development of social economy and continuous improvement of people's living standard, people have higher and higher requirements for life quality. Aromatherapy is a health care activity very beneficial to the human body, and when people inhale essence volatilized in the air, a function of physical conditioning can be achieved. However, an existing aroma stove is single in function, has use limitation and cannot meet people's use requirements. Therefore, a novel technical solution should be provided to solve the abovementioned problems.

### SUMMARY OF PRESENT INVENTION

An objective of the utility model is to provide a novel crystal salt aroma stove which is reasonable in design, attractive in appearance, simple and elegant, has an effect of air purification through crystal salt besides a function of aromatherapy and air beautification which an existing aroma stove can only perform, and enables users to breathe pure air, experience aesthetic sentiments, relax tense nerves and return to simple nature, so as to solve the problems mentioned in the background art.

In order to achieve the objective, the utility model provides the following technical solution: a novel crystal salt aroma stove, comprising an aroma stove body, a base and a built-in circuit control system. The aroma stove body is provided with the base, the built-in circuit control system is arranged in the base, a protective screen is arranged above the base, the top of the protective screen is provided with a cover, and the middle of the cover is provided with an aromatherapy oil placing groove.

Preferably, the side of the base is provided with a threading hole, the middle of the upper surface of the base is provided with a glass cover installing groove, a glass cover is arranged above the glass cover installing groove, and a heating bulb is disposed in the glass cover.

Preferably, the glass cover is a transparent cylinder.

Preferably, the protective screen is provided with meshes.

Preferably, a crystal salt placing groove is disposed between the protective screen and the glass cover.

Preferably, the built-in circuit control system is provided with a power supply module, one end of the power supply module is connected with a control circuit, and the other end of the power supply module is connected with one end of a light control module.

Compared with the prior art, the novel crystal salt aroma stove according to the utility model has the following beneficial effects:

The stove is reasonable in design, attractive in appearance, simple and elegant and has an effect of air purification through crystal salt besides a function of aromatherapy and air beautification which an existing aroma stove can only perform. After the crystal salt aroma stove is heated, a salt lamp emitting heat can be seen as a natural ion generator and can release anions and absorb moisture and neutralize excessive cations in the air. The crystal salt aroma stove according to the utility model can purify air, remove smell of cigarettes and odor in the air and absorb and remove dust mites, pollen, microbe spores and germs and the like in the air. The crystal salt lamp is gentle and pleasing to the eyes and can effectively relieve eyestrain and make users feel comfortable in eyes.

### DESCRIPTION OF THE DRAWINGS

FIG. 1 is a schematic diagram of an aroma stove body according to the utility model;

FIG. 2 is a schematic diagram of an internal structure of the aroma stove body according to the utility model;

FIG. 3 is a top view of the aroma stove body according to the utility model;

FIG. 4 is a schematic diagram of an aromatherapy oil placing groove according to the utility model; and

FIG. 5 is a schematic diagram of a built-in circuit control system according to the utility model.

In the figure, there is an aroma stove body 1, a cover 2, an aromatherapy oil placing groove 3, a protective screen 4, a base 5, a threading hole 6, a glass cover 7, a crystal salt placing groove 8, a heating bulb 9, a glass cover installing groove 10, a built-in circuit control system 11, a power supply module 12, a control circuit 13 and a light control module 14.

### DETAILED DESCRIPTION OF PREFERRED EMBODIMENTS

Technical solutions in embodiments of the utility model are described clearly and completely below with reference to the accompanying drawings in the embodiments of the utility model. Apparently, the described embodiments are only part of embodiments of the present invention rather than all embodiments. Based on the embodiments of the present invention, all other embodiments obtained by those skilled in the art without creative labor belong to the protective scope of the present invention.

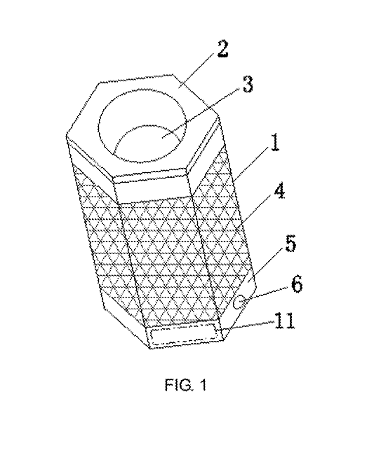

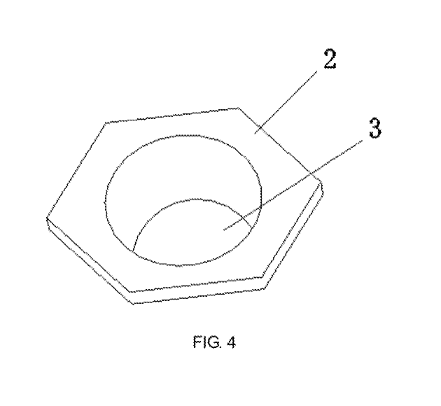

Referring to FIG. 1 or FIG. 4, the utility model provides a technical solution: a novel crystal salt aroma stove, comprising an aroma stove body 1, a base 5 and a built-in circuit control system 11; the aroma stove body 1 is a regular hexagonal cylindrical object and is provided with the base 5, the built-in circuit control system 11 is arranged in the base 5, a protective screen 4 is arranged above the base 5 and provided with parallelogram meshes, and the top of the protective screen 4 is provided with a cover 2. The cover 2 can be taken down randomly and is in a regular hexagon shape, and the middle of the cover 2 is provided with a round aromatherapy oil placing groove 3.

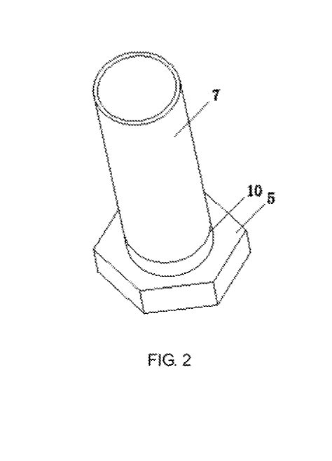

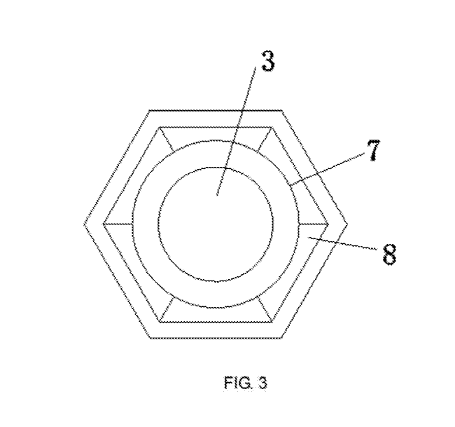

Referring to FIG. 2 or FIG. 3, the side of the base 5 is provided with a threading hole 6, the middle of the upper surface of the base 5 is provided with a glass cover installing groove 10, a glass cover 7 is arranged above the glass cover installing groove 10 and is a transparent cylinder, a heating bulb 9 is disposed in the glass cover, and a crystal salt placing groove 8 is disposed between the protective screen 4 and the glass cover 7.

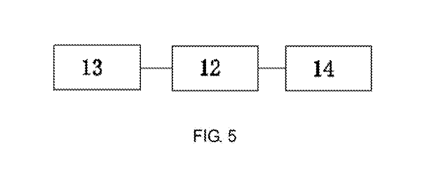

Referring to FIG. 5, the built-in circuit control system 11 is provided with a power supply module 12, one end of the power supply module 12 is connected with a control circuit 13, and the other end of the power supply module 12 is connected with one end of a light control module 14.

The novel crystal salt aroma stove is reasonable in design, attractive in appearance, simple and elegant, has an effect of air purification through crystal salt besides a function of aromatherapy and air beautification which an existing aroma stove can only perform, and enables users to breathe pure air, experience aesthetic sentiments, relax tense nerves and return to simple nature.

Although the embodiments of the utility model have been illustrated and described, it should be understood that those skilled in the art can perform various variations, modifications and replacements on these embodiments without departing from the principle and spirit of the utility model and the scope of the utility model is defined by the appended claims and equivalents thereof.

I claim:

1. A novel crystal salt aroma stove, comprising an aroma stove body (1), a base (5) and a built-in circuit control system (11), wherein the aroma stove body (1) is provided with the base (5), the built-in circuit control system (11) is arranged in the base (5), a protective screen (4) is arranged above the base (5), the top of the protective screen (4) is provided with a cover (2), and the middle of the cover (2) is provided with an aromatherapy oil placing groove (3).

2. The novel crystal salt aroma stove according to claim 1, wherein the side of the base (5) is provided with a threading hole (6), the middle of the upper surface of the base (5) is provided with a glass cover installing groove (10), a glass cover (7) is arranged above the glass cover installing groove (10), and a heating bulb (9) is disposed in the glass cover (7).

3. The novel crystal salt aroma stove according to claim 2, wherein the glass cover (7) is a transparent cylinder.

4. The novel crystal salt aroma stove according to claim 2, wherein the protective screen (4) is provided with meshes.

5. The novel crystal salt aroma stove according to claim 1, wherein a crystal salt placing groove (8) is disposed between the protective screen (4) and the glass cover (7).

6. The novel crystal salt aroma stove according to claim 1, wherein the built-in circuit control system (11) is provided with a power supply module (12), one end of the power supply module (12) is connected with a control circuit (13), and the other end of the power supply module (12) is connected with one end of a light control module (14).
